(19) United States
(12) Patent Application Publication
(10) Pub. No.: US 2023/0405905 A1
(43) Pub. Date: Dec. 21, 2023

(54) SYNTHETIC AGGREGATE

(71) Applicants: Alex VanHolten, Puslinch (CA); Alexander Bonnewell, Burlington (CA)

(72) Inventors: Alex VanHolten, Puslinch (CA); Alexander Bonnewell, Burlington (CA)

(21) Appl. No.: 17/752,322

(22) Filed: May 24, 2022

(51) Int. Cl. B29C 48/04; B29C 48/00

(52) U.S. Cl. CPC B29C 48/04; B29K 2105/26; B29C 48/001

(57) ABSTRACT

Synthetic aggregate includes a plastic material and, in some embodiments, an amount of air added into the plastic material. In some embodiments, the plastic material is recycled plastic material. The synthetic aggregate is formed via extrusion of the plastic material and subsequent shaping of the extruded plastic. In some embodiments, the amount of air is added into the plastic material prior to extrusion.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of construction materials of existing art and more specifically relates to a synthetic aggregate.

### RELATED ART

Aggregate includes material such as sand, gravel, stone, concrete and the like, and is used particularly in construction. Aggregate is provided in a variety of sizes and can be used in a wide range of applications, from being a component of asphalt to being a decorative feature for a patio or garden. As such, aggregate is a hugely in demand material in the construction industry.

There are however some problems associated with the aggregate available currently. Namely, because the aggregate is made from materials such as stone, the aggregate tends to be extremely heavy. This is of particular issue in large construction jobs that require a large amount of aggregate. The weight of aggregate causes excess strain on trucks and equipment, causes wear and tear on roads, causes strain on laborers, increases time needed on the job to transport the aggregate, increases amount of laborers needed, increases fuel costs, etc. As such, a suitable solution is needed to avoid these problems.

### SUMMARY OF THE INVENTION

In view of the foregoing disadvantages inherent in the known construction material art, the present disclosure provides a novel synthetic aggregate. The general purpose of the present disclosure, which will be described subsequently in greater detail, is to provide a synthetic aggregate, particularly, a plastic aggregate which is formed via extruding and shaping recycled plastic.

A plastic aggregate is disclosed herein. The plastic aggregate includes at least one plastic material and an amount of air. The at least one plastic material may be chosen based on desired hardness of the plastic aggregate. The amount of air may be added into the at least one plastic material. A ratio of plastic material to air may be chosen based on the desired hardness of the plastic aggregate.

According to another embodiment, a method of forming plastic aggregate is also disclosed herein. The method may include feeding at least one plastic material into a hopper of an extrusion machine; extruding the at least one plastic material to a desired density in the extrusion machine, thereby forming extruded plastic; and shaping the extruded plastic into a desired aggregate shape and size, thereby forming plastic aggregate.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a synthetic aggregate, constructed and operative according to the teachings of the present disclosure.

FIG. 1 is a top view of a plastic aggregate in one desired shape and size, according to an embodiment of the disclosure.

FIG. 2 is a top view of the plastic aggregate in another desired shape and size, according to another embodiment of the disclosure.

FIG. 3 is a flow diagram illustrating a method of forming the plastic aggregate, according to an embodiment of the present disclosure.

FIG. 4 is a flow diagram illustrating a method of forming the plastic aggregate, according to another embodiment of the present disclosure.

FIG. 5 is a flow diagram illustrating a method of forming the plastic aggregate, according to another embodiment of the present disclosure.

FIG. 6 is a flow diagram illustrating a method of forming the plastic aggregate, according to another embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to construction materials and more particularly to a synthetic aggregate. Generally, the synthetic aggregate may include a lightweight ‘stone’ made from recycled plastic. The synthetic aggregate may include similar or equal dimensions to standard quarry aggregate (for example ¾ and ¼) but may be between 10%-85% of the weight of the standard quarry aggregate. The synthetic aggregate may save on labor, fuel, time, and may lower environmental impact, as the use of recycled plastic may take away from landfills and water sources.

The synthetic aggregate may be manufactured using a basic plastic extrusion process. Air may be added before the extrusion occurs. The air may added via an aerator and/or a mixing process. After extrusion, the plastic may be placed into either a tumbler, a crusher or a shaper or may be blown or heat blasted to give it a desired aggregate shape and size. A ratio of plastic to air may be chosen based on desired hardness. Additionally, type of plastic may be chosen based on the desired hardness. Preferably, there may be a vast range in regard to air ratio and all plastics, ensuring the synthetic aggregate is suitable for different industries and applications.

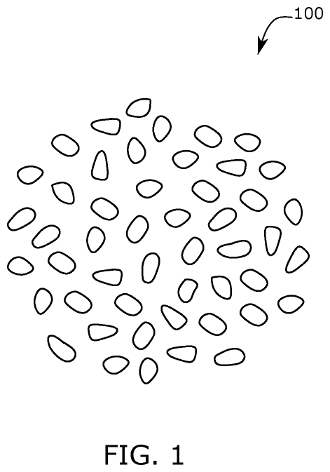

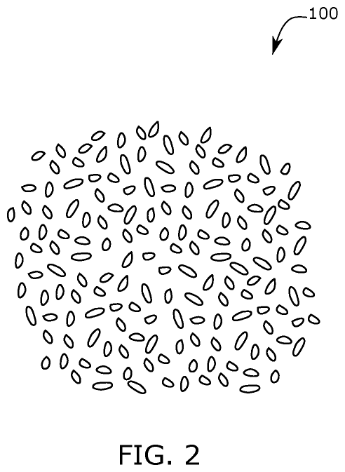

Referring now more specifically to the drawings, there is shown in FIGS. 1-6, various views of plastic aggregate 100 and methods 200, 300 of forming the plastic aggregate 100. FIGS. 1-2 demonstrate exemplary embodiments of the plastic aggregate 100. The plastic aggregate 100 may include at least one plastic material. Preferably, the at least one plastic material may include at least one recycled plastic material (but is not limited to recycled plastic). The plastic material may be chosen based on desired hardness of the plastic aggregate 100. The desired hardness of the plastic aggregate 100 may be based on industry in which the plastic aggregate 100 will be used, application for which the plastic aggregate 100 will be used, etc. For example, a hard plastic aggregate 100 may be desired for use in structural applications; as such acrylonitrile butadiene styrene (ABS) material and/or polyvinyl chloride (PVC) material may be chosen to form the plastic aggregate 100. In another example, a lighter plastic aggregate 100 may be desired for use in decorative garden applications; and as such, polypropylene may be chosen to form the plastic aggregate 100. It should be appreciated that these examples are given solely to aid in clarity and are not meant to limit the plastic material to any plastic mentioned herein.

Further, the plastic aggregate 100 may also include an amount of air. The amount of air may be added into the at least one plastic material (in some embodiments the recycled plastic material). A ratio of plastic material to air may also be chosen based on the desired hardness of the plastic aggregate 100. As such, as discussed above, the desired hardness of the plastic aggregate 100 may be based on industry in which the plastic aggregate 100 will be used and/or application for which the plastic aggregate 100 will be used, etc. For instance, using the examples above: for structural applications calling for hard plastic aggregate 100, little to no air may be added to the plastic material; for decorative garden applications calling for lighter plastic aggregate 100 a larger amount of air may be added. In a more detailed example, for structural applications, the plastic aggregate 100 may contain a plastic material to air ratio of 5:1; for decorative garden applications, the plastic aggregate 100 may contain a plastic material to air ratio of 2:1. Again, it should be appreciated that these examples are for clarification only and are not meant to limit the plastic aggregate 100 to any ratio.

The plastic aggregate 100 may preferably be formed via extrusion of the at least one recycled plastic material subsequent to the amount of air being added thereinto. In some embodiments, the amount of air may be added to the at least one recycled plastic material via an aerating process and/or a mixing process. The at least one recycled plastic material may then be shaped into a desired aggregate shape and size by tumbling, crushing, shaping in a shaper machine, blow molding and/or heat blasting. For example, as demonstrated in FIGS. 1-2, in some embodiments, the desired aggregate size may include an (approximately) ¾ size, an (approximately) ¼ inch size, and/or any other standard and/or custom size. In some examples, the desired aggregate size may also be dictated by the industry in which the plastic aggregate 100 will be used, application for which the plastic aggregate 100 will be used, etc. For example, structural applications may require larger sized plastic aggregate 100; and decorative garden applications may require smaller sized plastic aggregate 100.

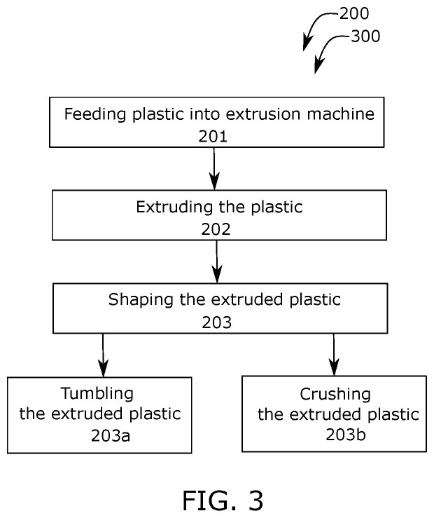

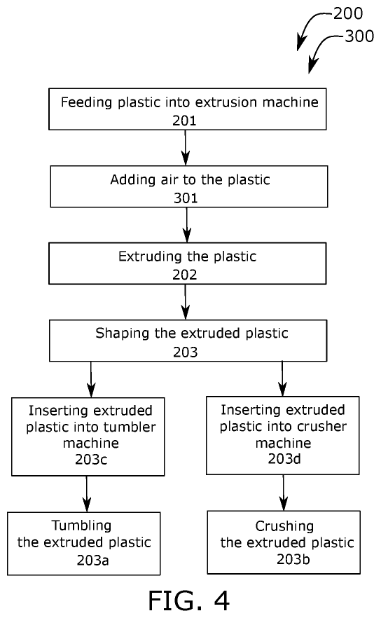

Referring more specifically now to FIGS. 3-4, illustrating methods 200, 300 of forming plastic aggregate 100. As discussed above, the plastic aggregate 100 may be formed via extrusion of the at least one (recycled) plastic material. As such, an extrusion machine may be used (not illustrated). As shown in FIGS. 3-4, the method 200, 300 may first include the step 201 of feeding the at least one plastic material into a hopper of the extrusion machine. Again, as discussed above, the at least one plastic material may be at least one recycled plastic material and may be chosen based on the desired hardness of the plastic aggregate 100. The at least one plastic material may be fed into the hopper in small plastic pieces.

In some embodiments, the next step 202 may include extruding the at least one plastic material to a desired density in the extrusion machine, thereby forming extruded plastic. The extrusion process utilized here may be a standard extrusion process and as such, the extrusion process utilized in the present invention may be understood by that knowledgeable in the art of extruding plastics. As shown in FIG. 4 and as discussed above, a step 301 of adding an amount of air into the at least one plastic material may be performed prior to the extruding step 202. The amount of air may be added using the extrusion machine or may be achieved in a unit in which also includes the extrusion machine.

For example, in some embodiments, the amount of air may be added to the at least one plastic material via an aerating process. In this example, the amount of air may be circulated about the at least one plastic material to impregnate the amount of air into the at least one plastic material. In another example, the amount of air may be added to the at least one plastic material via a mixing process, whereby the amount of air is simply mixed into the at least one plastic material. In both of these processes, the amount of air may be added to the at least one plastic material once the at least one plastic material has been melted, and again, prior to the actual extrusion of the at least one plastic material.

The next step 203 may include shaping the extruded plastic into a desired aggregate shape and size (as discussed above) thereby forming the plastic aggregate 100. As shown in FIGS. 3-6, this may be achieved by one or both of the substeps of tumbling 203a the extruded plastic; crushing 203b the extruded plastic; shaping 203c the extruded plastic; blow molding 203d the extruded plastic; and/or heat blasting 203e the extruded plastic.

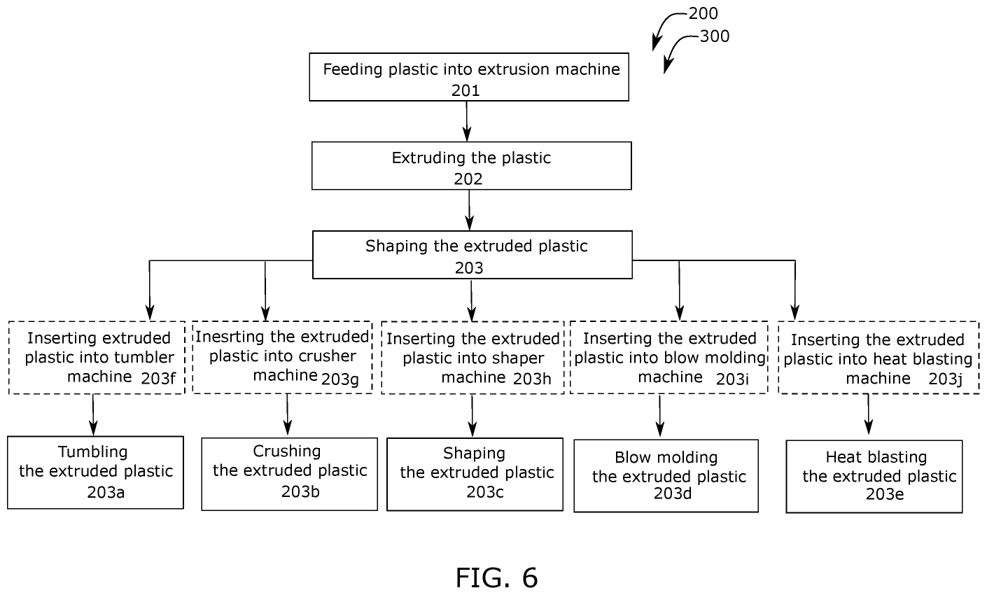

In some examples, the tumbling step 203a may be achieved via a tumbler machine. As such, as shown in FIG. 4 and FIG. 6, the method 300 may further include the step of inserting 203f the extruded plastic into the tumbler machine. In this step 203f the extruded plastic may be placed into the tumbler machine and tumbled for a particular amount of time, at a particular intensity, etc. based on the desired aggregate shape and size. Similarly, the crushing step 203b may be achieved via a crusher machine. As such, as shown in FIG. 4 and FIG. 6, the method 300 may further include the step of inserting 203g the extruded plastic into the crusher machine. A type of the crusher machine used may again depend on the desired aggregate shape and size. Again, as above, the step 203 may form plastic aggregate 100 of ¾ inch size and/or ¼ inch size. Further, custom sizes and shapes may be formed.

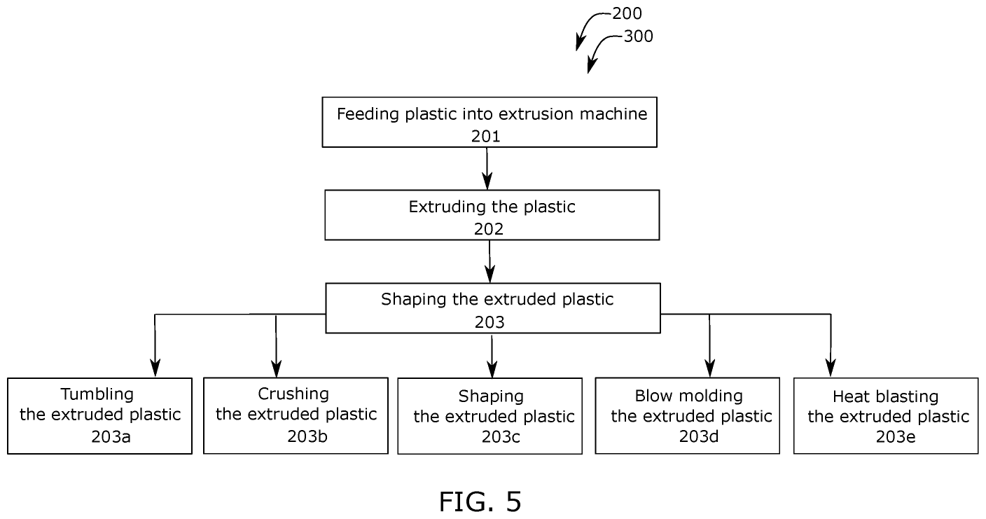

In addition, as shown in FIGS. 5-6 particularly, the shaping step 203c may be achieved via the shaper machine; the blow molding step 203d may be achieved by a blow molding machine; and/or the heat blasting step 203e may be achieved by a heat blasting machine. As such, as shown in FIG. 4, the method 300 may include the steps of: inserting 203h the extruded plastic into the shaper machine prior to shaping 203c the extruded plastic; inserting 203i the extruded plastic into the blow molding machine prior to blow molding 203d the extruded plastic; and/or inserting 203j the extruded plastic into the heat blasting machine prior to heat blasting 203e the extruded plastic.

It should be noted that certain steps are optional and may not be implemented in all cases. Some optional steps are indicated in FIG. 6 via broken lines. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for forming synthetic aggregate are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A method of forming plastic aggregate, the method comprising:
feeding at least one plastic material into a hopper of an extrusion machine;
extruding the at least one plastic material to a desired density in the extrusion machine, thereby forming extruded plastic; and
shaping the extruded plastic into a desired aggregate shape and size, thereby forming plastic aggregate.

2. The method of claim 1, wherein the step of shaping the extruded plastic into the desired aggregate shape and size is achieved by at least one of:
tumbling the extruded plastic;
crushing the extruded plastic;
shaping the extruded plastic in a shaping machine;
blow molding the extruded plastic; and
heat blasting the extruded plastic.

3. The method of claim 2, further comprising the step of:
adding an amount of air into the at least one plastic material.

4. The method of claim 3, wherein the amount of air is added to the at least one plastic material via an aerating process.

5. The method of claim 4, wherein the amount of air is added to the at least one plastic material via a mixing process.

6. The method of claim 5, wherein the step of adding the amount of air into the at least one plastic material is performed prior to the extruding step.

7. The method of claim 6, wherein a ratio of plastic material to air is chosen based on desired hardness of the plastic aggregate.

8. The method of claim 7, wherein the at least one plastic material is chosen based on the desired harness of the plastic aggregate.

9. The method of claim 8, wherein the at least one plastic material includes at least one recycled plastic material.

10. The method of claim 9, wherein the desired aggregate size includes a ¾ inch size and a ¼ inch size.

11. A method of forming plastic aggregate, the method comprising:
feeding at least one recycled plastic material into a hopper of an extrusion machine;
adding an amount of air into the at least one recycled plastic material;
extruding the at least one recycled plastic material to a desired density in the extrusion machine, thereby forming extruded plastic; and
shaping the extruded plastic into a desired aggregate shape and size, thereby forming plastic aggregate, by at least one of:
tumbling the extruded plastic;
crushing the extruded plastic;
shaping the extruded plastic in a shaping machine;
blow molding the extruded plastic; and
heat blasting the extruded plastic.

12. The method of claim 11, wherein the amount of air is added to the at least one recycled plastic material via at least one of an aerating process and a mixing process.

13. The method of claim 12, wherein the step of adding the amount of air into the at least one recycled plastic material is performed prior to the extruding step.

14. The method of claim 13, wherein a ratio of recycled plastic material to air is chosen based on desired hardness of the plastic aggregate.

15. The method of claim 14, wherein the at least one recycled plastic material is chosen based on the desired harness of the plastic aggregate.

16. The method of claim 15, wherein the desired aggregate size includes a ¾ inch size and a ¼ inch size.

17. A plastic aggregate comprising:
at least one plastic material, the at least one plastic material chosen based on desired hardness of the plastic aggregate; and
an amount of air added into the at least one plastic material, a ratio of plastic material to air chosen based on the desired hardness of the plastic aggregate.

18. The plastic aggregate of claim 17, wherein the at least one plastic material includes at least one recycled plastic material, wherein the plastic aggregate is formed via extrusion of the at least one recycled plastic material subsequent to the amount of air being added thereinto, and further shaped into a desired aggregate shape and size by at least one of tumbling, crushing, shaping in a shaper machine, blow molding and heat blasting.

19. The plastic aggregate of claim 18, wherein the amount of air is added to the at least one recycled plastic material via at least one of an aerating process and a mixing process.

20. The plastic aggregate of claim 19, wherein the desired aggregate size includes a ¾ inch size and a ¼ inch size.
